(19) United States
(12) Patent Application Publication
(10) Pub. No.: US 2006/0035650 A1
(43) Pub. Date: Feb. 16, 2006

(54) Central base for private radiocommunication local network and radiocommunication device comprising same

(75) Inventors: Oliver Amberny, Antony (FR); Bruno Deguet, Vulaine Sur Seine (FR); Henri-Nicolas Olivier, Levallois Perret (FR); Eric Carreel, Meudon (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: INVENTEL SYSTEMS, Paris (FR)

(21) Appl. No.: 10/526,707

(22) PCT Filed: Sep. 2, 2003
(86) PCT No.: PCT/FR03/02628

§ 371 Date: Mar. 3, 2005

(30) Foreign Application Priority Data
Sep. 3, 2002 (FR) 02/10887

(51) Int. Cl. H04Q 7/20

(52) U.S. Cl. 455/462; 455/426.2

(57) ABSTRACT

The invention concerns a central base for a private wireless local area network wherein the central base includes electronic circuits that include an electronic central unit and which is supplied with electricity with at least one live supply line intended to be connected to an external electricity power source. The central base is suitable for communicating on the one hand with a public telecommunication network, and on the other hand with at least one wireless peripheral device according to a digital bi-directional wireless protocol for a private wireless local area network.

The present invention relates to the central bases for private wireless local area networks, to wireless devices including such bases, and to private wireless local area networks including such devices.

More particularly, the invention concerns a central base for a private wireless local area network, this central base comprising electronic circuits that include an electronic central unit and that are supplied with electricity by at least one live supply line intended to be connected to an external electricity power source, said central base being suitable for communicating:
on the one hand, with a public telecommunication network,
and on the other hand, with at least one wireless peripheral device, according to a digital bidirectional wireless protocol for a private wireless local area network (for example the DECT protocol or the BLUETOOTH protocol).

It is often desirable to cause the central base to communicate with one or more external devices other than wireless peripheral devices, for example:
to interchange information with at least one home automation or other device, for the purpose of causing this home automation device to communicate indirectly either with wireless peripheral devices belonging to the private wireless local area network, or with remote devices via the public telecommunication network,
to test the central base, particularly when it leaves the factory,
to configure the central base and/or load data or software onto it, when it leaves the factory, when it is installed or when it is being used.

Because of the considerable cost constraints weighing on the production of central bases for private wireless local area networks, and so that the central base can be installed in the simplest possible manner by an inexperienced user, it is not desirable to add to the central base an additional connector used to communicate with external devices.

Furthermore, the central base may naturally communicate with an external device by radio channel according to said wireless protocol, but this communication involves giving the external device wireless capabilities complying with this protocol and consequently substantially increases the cost of said external device. In addition, such a radio communication requires the external device to be programmed in a manner complying with the configuration of the central base, which may pose problems particularly when the manufacturer of the external device in question is different from the manufacturer of the central base and/or when the manufacturer or the installer of the external device is not a wireless specialist.

The aim of the present invention is therefore to propose a central base of the type defined hereinabove, which can communicate with at least one external device without having an additional connector, without inducing substantial additional cost of said central base and without complicating the installation of this base and of said external device.

As a result, according to the invention, a central base of the type in question is characterized in that it comprises an interface circuit which is controlled by the electronic central unit of said central base and which is connected to said supply line, this interface circuit being suitable for sending and receiving messages on said supply line, and in that the interface circuit of the central base is suitable for sending and receiving high frequency periodic signals representative of messages sent and received, and the central base comprises a low-pass filter suitable for filtering said high frequency periodic signals between the interface circuit of the central base and at least a portion of the electronic circuits of the central base.

Thanks to these arrangements, the central base can be made to communicate by wire with an external device by connecting said external device to the supply line of the central base, therefore without the central base comprising an additional connector.

In preferred embodiments of the central base according to the invention, use may also be made where necessary of one and/or other of the following arrangements:
the interface circuit of the central base is installed in drop and insert mode on said supply line;
the interface circuit of the central base is suitable for sending and receiving periodic signals at a frequency lying between 100 and 500 kHz;
the interface circuit of the central base is controlled by the electronic central unit of the central base via a serial interface controller;
the central base is suitable for sending outgoing alphanumeric messages (particularly of the SMS type) at least to the public telecommunication network and for receiving incoming alphanumeric messages at least from said public telecommunication network, the electronic central unit of the central base being suitable for:
   (a) recognizing at least certain incoming alphanumeric messages intended for an external interface module, called service messages, and for causing to be generated on the supply line, by said interface circuit of the central base, a message corresponding to each incoming service message,
   (b) and when it receives a message received by the interface circuit of the central base on the supply line, determining whether this message must be transmitted to the outside and, in this case, sending an outgoing alphanumeric message, called outgoing service message, corresponding to the message received.
the central base is also suitable for sending outgoing alphanumeric messages to at least one wireless peripheral device by using said wireless protocol, and for receiving incoming alphanumeric messages from said wireless peripheral device (the service messages may thus also be interchanged with wireless peripheral devices of the local area network, particularly mobile telephones).

Furthermore, a further subject of the invention is a wireless device comprising a central base as defined hereinabove and an external interface module, distinct from the central base, which itself comprises:
an electronic central unit,
and an interface circuit controlled by said electronic central unit of the external interface module and which is connected to said supply line, this interface circuit of the external interface module being suitable for communicating with the interface circuit of the central base by sending and receiving messages on said supply line.

In preferred embodiments of the wireless device according to the invention, use may also be made where necessary of one and/or other of the following arrangements:
the interface circuit of the external interface module is installed in drop and insert mode on said supply line;
the interface circuit of the external interface module is suitable for sending and receiving high frequency periodic signals representative of messages sent and received, and the external interface module comprises a low-pass filter suitable for filtering said high frequency periodic signals between the interface circuit of the external interface module and an electricity supply device intended to connect said supply line to the external electricity power source;
the interface circuit of the external interface module is suitable for sending and receiving periodic signals at a frequency lying between 100 and 500 kHz;
the interface circuit of the external interface module is controlled by the electronic central unit of said external interface module via a serial interface controller;
the central base and the external interface module are suitable for communicating together according to a half-duplex asynchronous protocol;
the wireless device also comprises an external electronic device, distinct from the external interface module and communicating with the electronic central unit of said external interface module;
the external electronic device is chosen from a sensor, an actuator and a centralized command and control device suitable for being connected to a plurality of sensors and actuators;
the electronic central unit of the external interface module is suitable for causing messages intended to be sent by the central base in the form of outgoing service messages to be generated on the supply line, by the interface circuit of said external interface module.

Other features and advantages of the invention will appear during the following description of one of its embodiments, given as a nonlimiting example, with reference to the attached drawings.

### IN THE DRAWINGS

FIG. 1 is a diagram of a wireless local area network according to one embodiment of the invention, comprising a central base, an external interface module connected to a home automation device, and at least one mobile,

FIG. 2 is a block diagram illustrating the central base and the interface module connected to the home automation device,

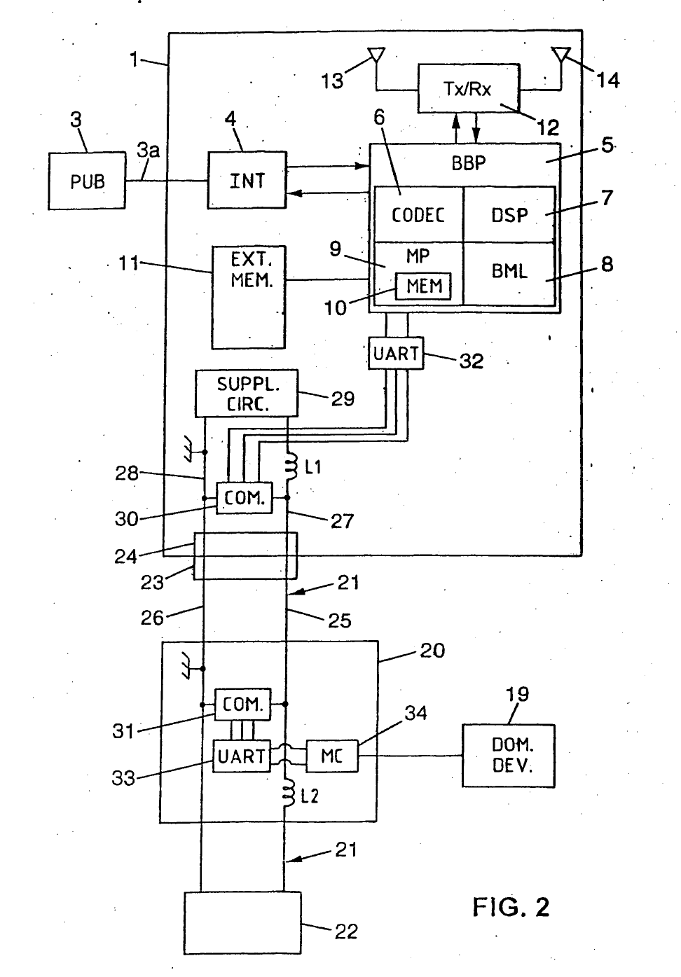

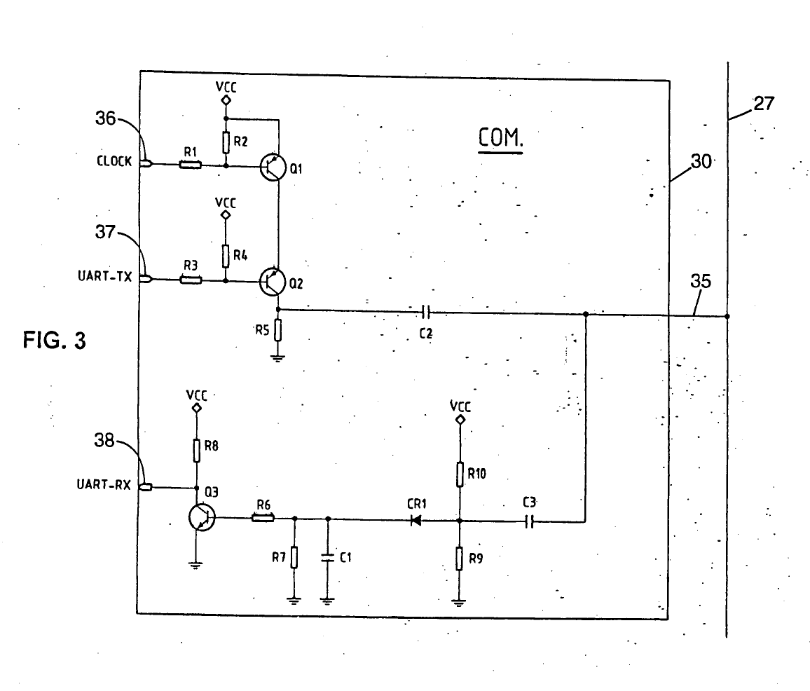

and FIG. 3 is a wiring diagram of an interface circuit belonging to the device of FIG. 2.

In the various figures, the same reference numbers refer to identical or similar elements.

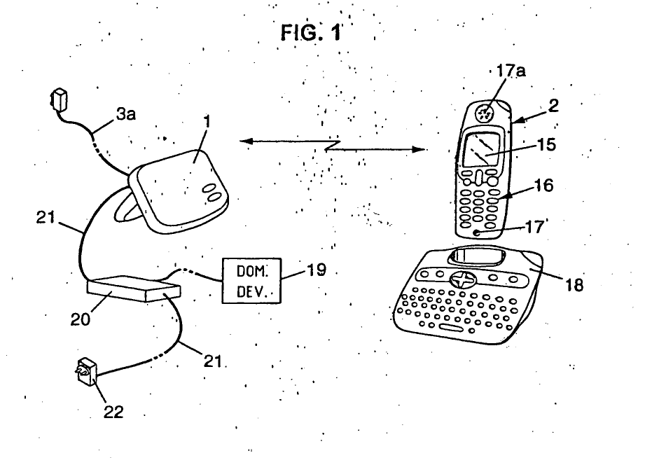

As shown in FIG. 1, the invention concerns a private wireless local area network operating under a digital bidirectional telecommunication protocol, preferably the “DECT” protocol or the “BLUETOOTH” protocol.

This wireless local area network comprises a central base 1, usually fixed, and one or more peripheral devices 2 usually mobile and consisting for example of portable wireless telephone handsets.

The central base 1 is connected to the public telephone network 3, usually via a wire link 3a forming a private connection to said public telephone network and connected to a telephone line of this network.

As shown in FIG. 2, this connection 3a is connected to an interface circuit 4 (INT) which communicates bidirectionally with a central unit 5 (BBP) or baseband processor.

The central unit 5 itself usually comprises several modules, in particular:
a module 6 (CODEC) suitable for modulating and demodulating the analog signals of the public network 3,
a processor (DSP) 7 suitable for carrying out various processes on the audio signals,
a burst mode logic circuit 8 (BML),
a microprocessor 9 (MP) preferably comprising an internal memory 10 (MEM) such as a random access memory or other.

In addition, the central unit 5 is usually also connected to an external memory 11 (EXT. MEM.) such as an EEPROM memory and a transmit and receive (Tx/Rx) radio circuit 12 itself connected to one or more transmit/receive antennae 13, 14.

Furthermore, each peripheral device 2, which communicates with the central base 1 by radio channel also comprises a central unit (not shown) identical or similar to the central unit 5 of the central base 1, a radio circuit and antennas (not shown) identical or similar to those 12, 13, 14 of the central base 1, and where appropriate an external memory (not shown) identical or similar to that 11 of the central base 1. In addition, the central unit of each peripheral device 2 is connected to an output interface such as a screen 15 (FIG. 1) and to an input interface such as a keyboard 16, likewise to a microphone 17 and to an earphone 17a.

The peripheral device or devices 2 may naturally be used conventionally to establish a voice communication, either between themselves, or with the outside via the public telecommunications network 3, but they may also be used to send or consult alphanumeric messages particularly of the SMS type (corresponding for example to the standard ETSI ES 201 912), for example as explained in document FR-A-2 819 972.

When the peripheral devices 2 are to be used for sending alphanumeric messages, these alphanumeric messages may be entered into the peripheral devices 2 either by means of their own keyboard 16, or by connecting said peripheral devices to an additional, more comprehensive keyboard 18, as described for example in French patent application No. 02 07644, filed on Jun. 20, 2002, by INVENTEL SYSTEMES.

Furthermore, according to the present invention, the alphanumeric messages in question are also used to cause one or more external electronic devices 19 (DOM. DEV.). particularly home automation devices, to communicate with the outside and/or with the peripheral device or devices 2, via the central base 1.

The home automation device 19 may where appropriate consist of:
a sensor, for example an intrusion detector, a fire detector, a water detector, a temperature sensor, or other,
an actuator, for example an electric blind control, a lighting control, a heating control, an alarm siren or other,
or yet a command and control device, itself connected to a set of sensors and/or actuators, for example an alarm station.

As shown in FIG. 1, each home automation device 19 is in connection with an interface module 20 external to the central base 1, by wire channel, by radio (according to a unidirectional or bidirectional wireless protocol), by infrared or other, which interface module 20 is connected to the electricity supply cable 21 of the central base 1.

This supply cable 21 connects the central base 1 to a supply module 22 which is connected to the AC electricity mains and which is usually suitable for producing a rectified periodic current of lower voltage than the current of the electricity mains, at a frequency usually less than 300 Hz, particularly of the order of 100 Hz when the mains supplies an AC voltage of 50 Hz.

As shown in FIG. 2, the electricity supply cable 21 comprises a connector 23 which is connected to an additional connector 24 of the central base 1. The electricity supply cable 21 comprises at least one live line 25 and one line 26 connected to earth, the line 25 being connected via the connectors 23, 24 to a live line 27 inside the central base 1 while the line 26 is connected via the connectors 23 and 24 to a line 28 connected to the base inside the central base 1.

The lines 27, 28 are connected to a supply circuit 29 (SUPPL. CIRC.) which supplies at least some of the electronic circuits of the central base 1.

Note that the electricity supply cable 21 could comprise several pairs of conductor lines supplying, where appropriate, several supply circuits inside the central base 1, in which case the interface module 20 and its internal components could be connected to only one of these pairs of conductor lines and insulated from the others. In particular, the electricity supply cable 21 could comprise two pairs of conductor lines, including one pair of conductor lines reserved for supplying a charger (not shown) integrated into the central base 1 and intended to recharge the batteries of the peripheral device 2, this pair of conductor lines being electrically insulated from the components of the interface module 20.

According to the invention, the interface module 20 communicates with the central base 1 via two interface circuits 30, 31 (COM.) belonging respectively to the central base 1 and to the interface module 20.

The interface circuit 30 is connected in drop and insert mode between the conductor lines 27, 28 while the interface circuit 31 is connected in drop and insert mode between the conductor lines 25, 26.

These two interface circuits 30, 31 are suitable for interchanging messages between them in the form of modulated electric signals, obtained by modulation (particularly amplitude modulation) of a carrier having a frequency preferably greater than 50 kHz and advantageously lying between 100 and 500 kHz, which carrier is transmitted over the supply line formed by the live lines 25, 27.

As an example, the transmission of a 0 bit by one of the two interface circuits 30, 31 may take the form of the transmission of the carrier over the live lines 25, 27 while the transmission of a 1 bit may take the form of the absence of a carrier over the live lines 25, 27, it being understood that the interface circuits 30, 31 transmit no carrier when they have no message to interchange between them.

To prevent these modulated signals from disrupting the operation of the central base 1 and of the supply module 22, and also to prevent these signals from being disrupted by this operation, a low-pass filter is advantageously provided on the live line 27 between the interface circuit 30 and the supply circuit 29, this low-pass filter advantageously being able to consist of an inductance L1, of a value for example of the order of 100 μH, installed in series on the conductor line 27.

For the same reasons, the interface module 20 may also comprise a low-pass filter between the interface circuit 31 and the supply module 22, this low-pass filter advantageously being able to consist of an inductance L2, of a value for example of the order of 100 μH, placed in series on the live line 25.

Each of the interface circuits 30, 31 may advantageously be controlled by a serial interface controller, particularly a universal asynchronous receiver/transmitter (UART).

The serial interface controller 32 of the base 1 itself communicates with the electronic central unit 5 of said base, while the serial interface controller 33 of the interface module 20 communicates with a microcontroller or microprocessor 34 (MC) belonging to said interface module. This microcontroller 34 further communicates with the home automation device or devices 19.

As shown in FIG. 3, the interface circuit 30 may comprise an input/output terminal 35 connected to the live line 27, a clock signal input terminal 36 (CLOCK) connected to a clock signal output terminal of the serial interface controller 32, a data input terminal (UART-TX) connected to the data transmission terminal of the serial interface controller 32, and a data output terminal 38 (UART-RX) connected to the data reception terminal of the serial interface controller 32.

The clock signal input terminal 36 is connected, via a resistor R1 (having for example a value of the order of 4.7 kΩ), to the base of a PNP transistor Q1 (for example of the BC807 type).

The transmitter of this transistor is furthermore connected to an electricity supply terminal at a VCC direct voltage equal for example to 3 Volts or, where appropriate, to 5 Volts, this supply terminal itself being connected to a direct current supply circuit (not shown) itself supplied via the live line 27.

The base of the transistor Q1 is connected to the VCC supply terminal via a resistor R2 (rated for example at approximately 4.7 kΩ), and the collector of the transistor Q1 is connected to the transmitter of a PNP transistor Q2 (for example of the BC807 type).

The collector of this transistor Q2 is connected to earth via a resistor R5 (rated for example at approximately 100 kΩ) whose transmitter is connected to the data input terminal 37 via a resistor R3 (rated for example at approximately 4.7 kΩ), the base of the transistor Q2 furthermore being connected to the VCC supply terminal via a resistor R4 (rated for example at approximately 4.7 kΩ).

The collector of the transistor Q2 is also connected to the input/output terminal 35, via a capacitor C2 serving as a low-pass filter and rated for example at approximately 10 nF.

Thus, when the data input terminal 37 receives a high signal, corresponding to a 1 bit, the transistor Q2 is not on-state, so no signal is transmitted to the input/output terminal 35, whereas when the data input terminal 37 receives a low signal, corresponding to a 0 bit, the transistor Q2 is on-state and allows the carrier received by the clock signal terminal 36 to pass to the input/output terminal 35.

This input/output terminal 35 is also connected to the base of a NPN transistor Q3 (for example of the BC817 type), via:
a capacitor C3 serving as a high-pass filter and rated for example at approximately 1 nF,
a diode CR1 (for example of the 1N4148 type) which is on-state to the base of the transistor Q3,
and a resistor R6 rated for example at approximately 33 kΩ.

The transmitter of the transistor Q3 is connected to earth and its collector is connected, on the one hand, to the data output terminal 38 and, on the other hand, to the VCC supply terminal via a resistor R8 which may be of the order of 33 kΩ.

Between the diode CR1 and the resistor R6 the following may furthermore be connected in drop and insert mode:
a resistor R7 rated for example at approximately 56 kΩ and connected to earth,
and a capacitor C1 rated for example at approximately 470 pF.

Between the capacitor C3 and the diode CR1 there may also be connected in drop and insert mode, on the one hand, a resistor R10 rated at approximately 100 kΩ and connected to the VCC supply terminal (this rating is valid for a supply voltage of 3 Volts, and would advantageously be raised to approximately 150 kΩ for a supply voltage of 5 Volts), and, on the other hand, a resistor R9 connected to earth and rated for example at approximately 33 kΩ.

Thus, when a high frequency modulated signal is present on the live line 27, this signal is transmitted to the data output terminal 38 connected to the serial interface controller 32.

The capacitors C2 and C3 make it possible for the voltage variations of relatively low frequencies present on the live line 27 when it is supplied by a rectified periodic voltage not to disrupt the operation of the electronic components of the interface circuit 31.

Furthermore, the capacitor C1 is used to smooth the high frequency signal received from the input/output terminal 35 in order to convert it into a continuous signal when such a signal is present on the live line 27, such that the output terminal 38 transmits either a low signal, or a high signal, depending on whether the high frequency carrier is or is not present at the input/output terminal 35.

The interface circuit 31 of the interface module 20 is furthermore identical to the interface circuit 30 previously described, except that only its input/output terminal 35 is connected to the live line 25 and that its terminals 36, 37, 38 are connected to the corresponding terminals of the serial interface controller 33.

Thanks to these arrangements, the interface module 20 can be made to communicate with the central base 1 according to a conventional RS 232 serial protocol of the half-duplex type, the data being coded for example on 8 bits with one start bit and one stop bit.

The serial interface controllers 32, 33 are furthermore suitable for detecting message collisions, that is to say simultaneous message transmissions by each of them, and for resending, with different time delays, the messages or the portions of messages that have collided.

Thanks to the communication thus established between the central base 1 and the interface module 20, this interface module 20 can generate alphanumeric messages which are transmitted to the central base 1 and which the latter may, at least in certain cases, convert into SMS type messages, in order to send them to a recipient outside the wireless local area network, via the public network 3.

The central base 1 may furthermore transmit the alphanumeric messages originating from the interface module 20 to one or more peripheral devices 2 of the wireless local area network.

Such transmissions of alphanumeric messages may take place:
either when a predetermined event detected by the home automation device 19 occurs,
or at predetermined moments, for example when it is desirable to send, to the outside of the network or to a peripheral device 2 of the network, an update of information originating from the home automation device 19,
or in reaction to an SMS alphanumeric message received by the central base 1, from outside the wireless local area network or, where appropriate, from one of the peripheral devices 2 of the local area network (in the latter case, the message received by the base 1 could be of the non-SMS type).

When the central base 1 receives an alphanumeric SMS type message from the public telecommunication network 3 or from one of the peripheral devices 2 of the wireless local area network, this incoming alphanumeric message is recognized by the central unit 5 of the base 1 as being of the SMS type, in conventional manner. Furthermore, if it is a message intended to be transmitted to the interface module 20, this message comprises a predetermined code which the electronic central unit 5 of the base 1 is capable of recognizing.

In this case, the alphanumeric message is identified as being a “service” message intended for the interface module 20, and said alphanumeric message is converted by the central base 5 into a message conforming to the serial communication protocol to be transmitted to the serial interface controller 32 which then sends corresponding signals to the interface circuit 30.

This interface circuit 30 then generates corresponding modulated signals on the live lines 27, 25, so that these signals are received by the interface circuit 31, then transmitted to the serial interface controller 33, which serial interface controller 33 itself transmits this message to the microcontroller 34.

It is thus possible, by sending an SMS type alphanumeric message to the central base 1, either to control the home automation device 19 or to ask the microcontroller 34 for information concerning the home automation device 19, for example measurement values or states of on/off sensors.

When such an incoming service message has been transmitted to the interface module 20, said interface module 20 may then reply to it, in which case the microcontroller 34 generates a message intended to be forwarded in SMS alphanumeric message form, which message is first transmitted to the serial interface controller 33, then to the interface circuit 31, then to the interface circuit 30, to the serial interface controller 32 and finally to the electronic central unit 5 of the central base 1, which electronic central unit generates the outgoing SMS alphanumeric message (here called outgoing service message since it comes from the interface module 20) intended to be sent to the public telecommunication network 3 or to one or more peripheral devices 2 of the wireless local area network.

The messages sent according to the serial protocol between the central unit 1 and the interface module 20 may advantageously be sent in the form of predetermined frames.

For example, the messages generated by the microcontroller 34 and transmitted to the electronic central unit 5 of the central base may be presented in the following form:
a start-of-frame signal,
an octet indicating the length of the frame in number of octets,
an octet reserved for the type of SMS command,
an octet reserved for an SMS subcommand,
an octet indicating the size of the called address (indicating the number n of octets of the called address),
the called address, on n octets, that is to say, for example, the telephone number or address within the wireless local area network, of the recipient of the SMS message,
an octet indicating the size of the content of the message, that is to say the number p of octets corresponding to the content of the message,
the content of the message, on p octets,
a message integrity verification key, on one octet,
and an end-of-frame signal.

Other predefined frames are provided when the central unit 1 transmits an incoming SMS alphanumeric message to the interface module 20, when the interface module 20 will consult a mailbox of messages stored for example in the memory of the central unit 1, etc.

Note that the interface module 20 could be used not for receiving messages corresponding to incoming SMS messages or for sending messages intended to be converted into outgoing SMS messages, but for example:
for connecting to an electronic device such as a GSM, UMTS or other mobile telephone, or yet a personal digital assistant (PDA), particularly for:
   downloading data from this electronic device to the central base 1 and/or to the peripheral device or devices 2,
   or for transferring data from the peripheral device or devices 2 and/or from the central base 1 to this electronic device, for example in order to transfer a directory of telephone addresses or other,
   for synchronizing telephone address directories or other present both on the electronic device connected to the interface module 20 and on the central unit 1 or the peripheral devices 2,
   or yet for transferring or synchronizing any other files or set of digital files such as: timetable, jobs to do, etc.;
or yet, particularly when the central base 1 is operating according to the DECT protocol, causing this central base 1 to communicate with a radio detector operating according to the BLUETOOTH standard, connected to the interface module 20 or integrated into this module, so that the BLUETOOTH device can inform the central base 1 of the presence or absence of a user having a mobile telephone (particularly of the GSM or UMTS type) itself furnished with a communication device to the BLUETOOTH standard: the central base 1 may then inform the outside network to which it is connected when it determines that this user is absent, so that this network then automatically transfers to said mobile telephone the incoming calls which would normally be intended to pass through said base 1;
for transferring into the central base 1 programs or operating parameters, or other data, particularly when leaving the factory, when the central base 1 is dispatched or commissioned, in which case the interface module 20 may be connected for example to a personal computer or similar intended to carry out this information transfer,
or yet for testing the base 1 particularly when leaving the factory, in which case the interface module 20 may be connected to a personal computer or other device making it possible to run the tests required to verify that the central base 1 is operating correctly.

Note furthermore that the interface module 20, instead of being installed in series on the electricity supply cable 21, could be installed in drop and insert mode either on this cable, or on a specific connector so that, for example, this cable can be connected to the central base 1.

Note finally that several interface modules 20 could be connected to the same central base 1 as previously described, and that several home automation devices 19 could communicate with each interface module 20.

1. A central base for a private wireless local area network, this central base comprising electronic circuits that include an electronic central unit and that are supplied with electricity by at least one live supply line intended to be connected to an external electricity power source, said central base being suitable for communicating:
on the one hand, with a public telecommunication network (3),
and on the other hand, with at least one wireless peripheral device, according to a digital bidirectional wireless protocol for a private wireless local area network,
characterized in that it comprises an interface circuit which is controlled by the electronic central unit of said central base and which is connected to said supply line, this interface circuit being suitable for sending and receiving messages on said supply line,
and in that the interface circuit of the central base is suitable for sending and receiving high frequency periodic signals representative of sent and received messages, and the central base comprises a low-pass filter suitable for filtering said high frequency periodic signals between the interface circuit of the central base and at least a portion of the electronic circuits of the central base.

2. The central base as claimed in claim 1, in which the interface circuit of the central base is installed in drop and insert mode on said supply line.

3. The central base as claimed in claim 1, in which the interface circuit of the central base is suitable for sending and receiving periodic signals at a frequency lying between 100 and 500 kHz.

4. The central base as claimed in claim 1, in which the interface circuit of the central base is controlled by the electronic central unit of the central base via a serial interface controller.

5. The central base as claimed in claim 1, suitable for sending outgoing alphanumeric messages at least to the public telecommunication network and for receiving incoming alphanumeric messages at least from said public telecommunication network, the electronic central unit of the central base being suitable for:
(a) recognizing at least certain incoming alphanumeric messages intended for an external interface module, called service messages, and for causing to be generated on the supply line, by said interface circuit of the central base, a message corresponding to each incoming service message,
(b) and when it receives a message received by the interface circuit of the central base on the supply line, determining whether this message must be transmitted to the outside and, in this case, sending an outgoing alphanumeric message, called outgoing service message, corresponding to the message received.

6. The central base as claimed in claim 5, also suitable for sending outgoing alphanumeric messages to at least one wireless peripheral device by using said wireless protocol, and for receiving incoming alphanumeric messages from said wireless peripheral device.

7. A wireless device comprising a central base as claimed in claim 1 and an external interface module, distinct from the central base, which itself comprises:
an electronic central unit,
and an interface circuit controlled by said electronic central unit of the external interface module and which is connected to said supply line, this interface circuit of the external interface module being suitable for communicating with the interface circuit of the central base by sending and receiving messages on said supply line.

8. The wireless device as claimed in claim 7, in which the interface circuit of the external interface module is installed in drop and insert mode on said supply line.

9. The wireless device as claimed in claim 7, in which the interface circuit of the external interface module is suitable for sending and receiving high frequency periodic signals representative of messages sent and received, and the external interface module comprises a low-pass filter (L2) suitable for filtering said high frequency periodic signals between the interface circuit of the external interface module and an electricity supply device intended to connect said supply line to the external electricity power source.

10. The wireless device as claimed in claim 7, in which the interface circuit of the external interface module is suitable for sending and receiving periodic signals at a frequency lying between 100 and 500 kHz.

11. The wireless device as claimed claim 7, in which the interface circuit of the external interface module is controlled by the electronic central unit of said external interface module via a serial interface controller.

12. The wireless device as claimed in claim 7, in which the central base and the external interface module are suitable for communicating together according to a half-duplex asynchronous protocol.

13. The wireless device as claimed in, also comprising an external electronic device distinct from the external interface module and communicating with the electronic central unit of said external interface module.

14. The wireless device as claimed in claim 13, in which the external electronic device is chosen from a sensor, an actuator and a centralized command and control device suitable for being connected to a plurality of sensors and actuators.

15. The wireless device as claimed in claim 7, comprising a central base, and in which the electronic central unit of the external interface module is suitable for causing messages intended to be sent by the central base in the form of outgoing service messages to be generated on the supply line, by the interface circuit of said external interface module.
